(19) United States
(12) Patent Application Publication
(10) Pub. No.: US 2008/0100459 A1
(43) Pub. Date: May 1, 2008

(54) Arrangement for and method of maintaining proper posture

(76) Inventors: Evan Hoffman, New York, NY (US); Shaun Fogarty, Portland, OR (US)

Correspondence Address: KIRSCHSTEIN, OTTINGER, ISRAEL;& SCHIFFMILLER, P.C., 489 FIFTH AVENUE, NEW YORK, NY, 10017, US

(21) Appl. No.: 11/975,451

(22) Filed: Oct. 19, 2007

Related U.S. Application Data
(60) Provisional application No. 60/854,233, filed on Oct. 25, 2006.

(51) Int. Cl. G08B 21/00

(52) U.S. Cl. 340/573.7

(57) ABSTRACT

A posture device that is worn on the body of a wearer includes a tilt sensor that is initially calibrated to a set value. A microprocessor monitors the tilt angle during wearing of the device and, if the tilt angle deviates from the set value over a predetermined time period, then a vibrator is actuated to remind the wearer to maintain good posture.

### CROSS REFERENCE TO RELATED APPLICATION

This application claims the benefit of U.S. Provisional Patent Application Ser. No. 60/854,233, filed Oct. 25, 2006.

### BACKGROUND OF THE INVENTION

The invention relates to a device designed to train its wearer to assume a good posture at all times.

Good posture is important, but unfortunately many people do not maintain a proper, upright stance while standing, which is conducive to good health and appearance. Overweight people often find it difficult to maintain proper posture. Persons injured will tend to favor a position that may not be the best for proper healing or therapy. Senior citizens tire more quickly and may tend to slouch, which is injurious to vertebrae of the back. Proper posture, even while sitting at a desk, is important. Proper posture can conserve energy and make a worker more productive as well as maintaining an alert appearance.

### SUMMARY OF THE INVENTION

One feature of this invention resides in an electromechanical posture-maintaining device that will offer a subtle reminder to the wearer when good posture is not being maintained. The posture device is harmless to the wearer and is worn on the body under normal outerwear and out of sight. The device includes a housing that is preferably positioned at the lower back area and held in place by a belt strapped around the waist, but it is not limited to this area, because it could be worn at the waist, or at upper back or chest areas of the wearer.

The housing contains a tilt sensor for sensing the tilt of the housing, a vibrator for producing vibrations, a microprocessor for controlling the operation of the tilt sensor and the vibrator, a battery pack for supplying electrical power, and a pair of adjustable controls. An on/off power switch positioned on the housing connects and disconnects the battery pack to the electrical components. One of the controls is a vibrator potentiometer for manually adjusting the amplitude of vibrations produced by the vibrator. Another of the controls is a tilt potentiometer for manually adjusting the sensitivity of tilt produced by the tilt sensor. The tilt sensor is sensitive to one-tenth of a degree of tilt angle.

Once initially positioned on the wearer, the on/off switch is depressed, and the wearer is instructed to hold a desired posture during a calibration mode. The microprocessor is programmed to use the tilt angle measured during this calibration mode as a set or reference point. Any deviation from this set point thereafter causes the microprocessor to generate an output control signal to the vibrator and causes vibrations to be produced. Alternatively, an alarm or buzzing sounds could be generated when the wearer assumes a stance or slouching posture that is incorrect. The vibrations or other alarm remind the wearer to resume his correct posture.

In order to prevent the vibrator from actuating purely from the simple act of taking a deep breath, or sneezing, or minor slouching, or deviation from the set point, the microprocessor measures the tilt angle from the tilt sensor over a predetermined time period and determines an average and a frequency of the angle change. The output control signal is generated only when the tilt angle exceeds a predetermined threshold over the predetermined time period.

Should the wearer, for any reason, want to temporarily disable the vibrator, the wearer simply moves the on/off switch to the off position and the device will not actuate. This would be necessary to avoid wearer embarrassment when in meetings or other situations.

Another feature of this invention resides in a method of maintaining a proper body posture for a user, comprising the steps of sensing tilt of a body of the user; setting a reference value of the tilt indicative of the proper body posture during a calibration mode; generating a control signal when the sensed tilt differs from the reference value during an operational mode; and producing an alert when the control signal is generated to advise the user that the proper body posture has not been maintained and should be resumed. Thus, use of the instant invention will benefit the wearer by subtly reminding him or her when good posture is violated. Soon good posture will become a habit to the wearer, and the good health and appearance benefits will accrue to its owner.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a rear perspective diagrammatic view of a posture device worn by a wearer in accordance with this invention;

FIG. 2 is an enlarged perspective view of a housing of the device of FIG. 1;

FIG. 3 is an electrical schematic of components within the housing of FIG. 2; and

FIG. 4 is a top perspective view of the housing of FIG. 2 exposed to reveal its components.

### DETAILED DESCRIPTION OF THE PREFERRED EMBODIMENT

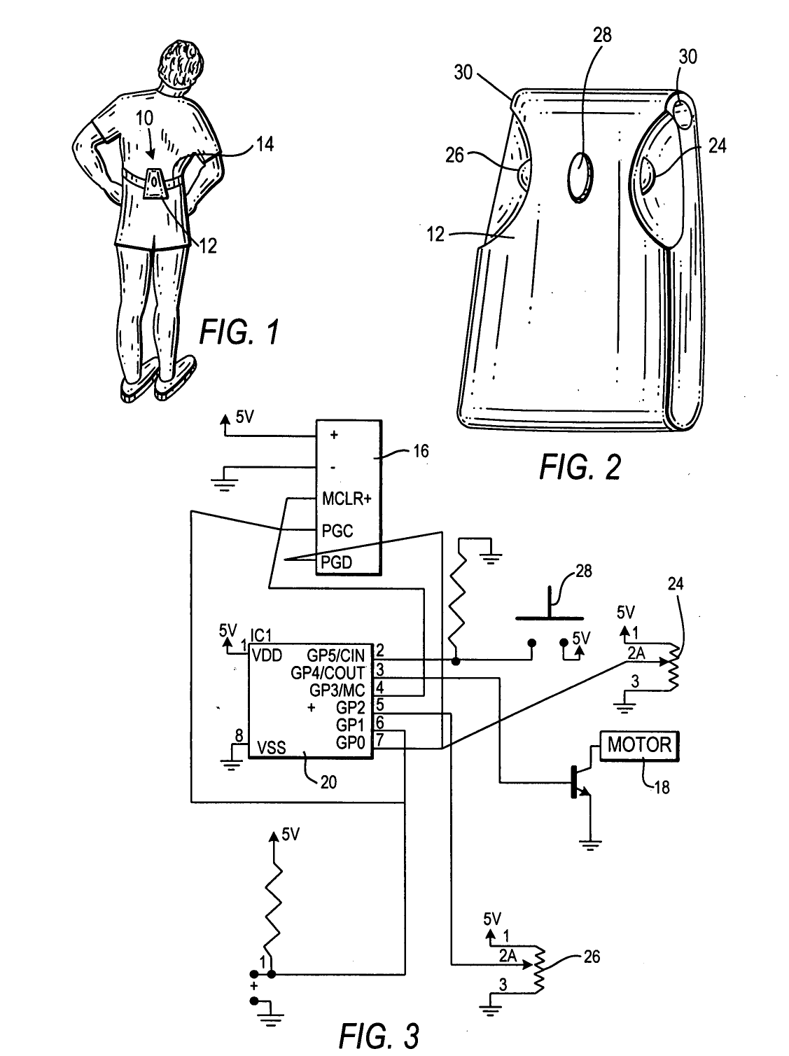

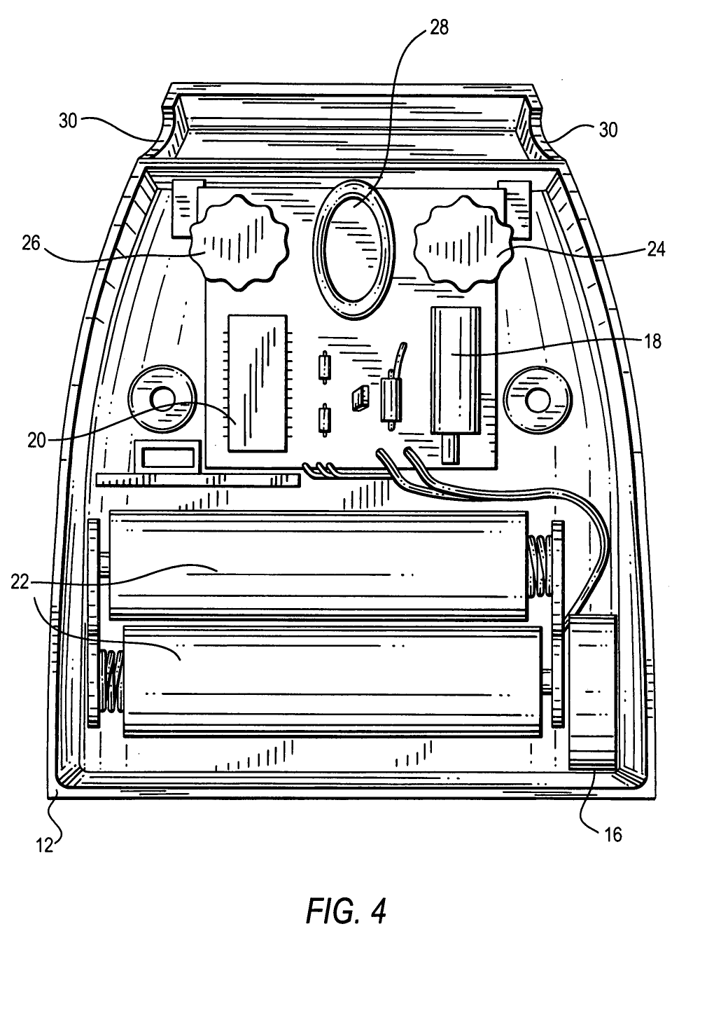

The posture device and method of this invention will now be described by referring to FIGS. 1-4 of the drawings. The posture device is generally designated by reference numeral 10.

The posture device 10 is harmless to the wearer and is worn on the body under normal outerwear and out of sight. The device 10 includes a housing 12 that is preferably positioned at the lower back area, as shown in FIG. 1, and held in place by a belt 14 strapped around the waist, but it is not limited to this area, because it could be worn at the waist, or at upper back or chest areas of the wearer. The housing 12 is formed with holes 30 through which the belt 12 is passed.

The housing 12 contains a tilt sensor 16 for sensing the tilt of the housing 12, a vibrator 18 for producing vibrations, a microprocessor 20 for controlling the operation of the tilt sensor 16 and the vibrator 18, a battery pack 22 for supplying electrical power, and a pair of adjustable controls 24, 26. An on/off power switch 28 positioned on the housing 12 connects and disconnects the battery pack 22 to the electrical components. One of the controls is a vibrator potentiometer 24 for manually adjusting the amplitude of vibrations produced by the vibrator 18. Another of the controls is a tilt potentiometer 26 for manually adjusting the sensitivity of tilt produced by the tilt sensor 16. The tilt sensor 16 is sensitive to one-tenth of a degree of tilt angle.

Once initially positioned on the wearer, the on/off switch 28 is depressed, and the wearer is instructed to hold a desired posture during a calibration mode. The microprocessor 20 is programmed to use the tilt angle measured during this calibration mode as a set or reference point. Any deviation from this set point thereafter causes the microprocessor 20 to generate an output control signal to the vibrator 18 and causes vibrations to be produced. Alternatively, an alarm or buzzing sounds could be generated when the wearer assumes a stance or slouching posture that is incorrect. The vibrations or other alarm remind the wearer to resume his or her correct posture.

In order to prevent the vibrator 18 from actuating purely from the simple act of taking a deep breath, or sneezing, or minor slouching, or deviation from the set point, the microprocessor 20 measures the tilt angle from the tilt sensor 16 over a predetermined time period and determines an average and a frequency of the angle change. The output control signal is generated only when the tilt angle exceeds a predetermined threshold over the predetermined time period.

Should the wearer, for any reason, want to temporarily disable the vibrator, the wearer simply moves the on/off switch 28 to the off position and the device 10 will not actuate. This would be necessary to avoid wearer embarrassment when in meetings or other situations.

In another embodiment, the housing is not strapped with the belt 14 around the wearer's waist. Instead, a clip is provided on the housing, and the device is clipped on the wearer's clothing, either outerwear or underwear, for example on the waistband of a pair of pants or a skirt, or a belt used to hold up a pair of pants, or a sports bra. The clip itself could be removed, and the device simply slipped into a wearer's front shirt or blouse pocket.

In still another embodiment, a separate housing is not needed. Instead, the components described above can be mounted within the housing of an existing electronic device, such as a portable telephone, a pager, a music player, a video player, or a personal digital assistant, which devices typically have, or can readily be equipped with, a clip that is clipped onto the wearer's clothing.

Thus, use of the instant invention will benefit the wearer by subtly reminding him or her when good posture is violated. Soon good posture will become a habit to the wearer, and the good health and appearance benefits will accrue to its owner.

It will be understood that each of the elements described above, or two or more together, also may find a useful application in other types of constructions differing from the types described above.

While the invention has been illustrated and described as an arrangement for and method of maintaining proper posture, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention and, therefore, such adaptations should and are intended to be comprehended within the meaning and range of equivalence of the following claims.

What is claimed as new and desired to be protected by Letters Patent is set forth in the appended claims:

We claim:

1. An arrangement for maintaining a proper body posture for a user, comprising:
a tilt sensor for sensing tilt of a body of the user;
a controller operatively connected to the tilt sensor, for setting a reference value of the tilt indicative of the proper body posture during a calibration mode, and for generating a control signal when the tilt sensed by the tilt sensor differs from the reference value during an operational mode; and
an alarm operatively connected to the controller, for producing an alert when the control signal is generated to advise the user that the proper body posture has not been maintained and should be resumed.

2. The arrangement of claim 1, and a control for manually adjusting sensitivity of the tilt sensed by the tilt sensor.

3. The arrangement of claim 1, and a control for manually adjusting an amplitude of the alert produced by the alarm.

4. The arrangement of claim 1, wherein the controller is operative for processing the tilt sensed by the tilt sensor over a time period to obtain an average tilt value, and for generating the control signal when the average tilt value differs from the reference value.

5. The arrangement of claim 1, wherein the alarm is a vibrator for producing the alert as vibrations.

6. The arrangement of claim 1, and a power supply for supplying electrical power to the controller, and a power switch for manually switching the power on and off to the controller.

7. The arrangement of claim 1, and a housing worn by the user, for supporting the tilt sensor, the controller, and the alarm.

8. The arrangement of claim 7, and a belt strapped on the body of the user, and wherein the housing has a passage through which the belt is passed to supportably position the housing on the body of the user.

9. The arrangement of claim 7, wherein the housing has openings; and a first control accessible through one of the openings, for manually adjusting sensitivity of the tilt sensed by the tilt sensor; and a second control accessible through another of the openings, for manually adjusting an amplitude of the alert produced by the alarm.

10. A device for maintaining a proper body posture for a user, comprising:
a housing worn by the user;
a tilt sensor supported by the housing, for sensing tilt of a body of the user;
a controller supported by the housing and operatively connected to the tilt sensor, for setting a reference value of the tilt indicative of the proper body posture during a calibration mode, and for generating a control signal when the tilt sensed by the tilt sensor differs from the reference value during an operational mode; and
an alarm supported by the housing and operatively connected to the controller, for producing an alert when the control signal is generated to advise the user that the proper body posture has not been maintained and should be resumed.

11. The device of claim 10, and a belt strapped on the body of the user, and wherein the housing has a passage through which the belt is passed to supportably position the housing on the body of the user.

12. The device of claim 10, wherein the housing has openings; and a first control accessible through one of the openings, for manually adjusting sensitivity of the tilt sensed by the tilt sensor; and a second control accessible through another of the openings, for manually adjusting an amplitude of the alert produced by the alarm.

13. A method of maintaining a proper body posture for a user, comprising the steps of:
sensing tilt of a body of the user;
setting a reference value of the tilt indicative of the proper body posture during a calibration mode;
generating a control signal when the sensed tilt differs from the reference value during an operational mode; and
producing an alert when the control signal is generated to advise the user that the proper body posture has not been maintained and should be resumed.

14. The method of claim 13, and manually adjusting sensitivity of the sensed tilt.

15. The method of claim 13, and manually adjusting an amplitude of the alert.

16. The method of claim 13, wherein the generating step is performed by processing the sensed tilt over a time period to obtain an average tilt value, and by generating the control signal when the average tilt value differs from the reference value.

17. The method of claim 13, and manually disabling the alert.
